(19) United States
(12) Patent Application Publication
(10) Pub. No.: US 2005/0125387 A1
(43) Pub. Date: Jun. 9, 2005

(54) Method of joining data and its metadata using dynamic metadata in relational database

(75) Inventors: Douglas R. Fish, Rochester, MN (US); Hoa T. Tran, Rochester, MN (US)

Correspondence Address: William J. McGinnis, Jr.;IBM Corporation, Dept. 917, 3605 Highway 52 North, Rochester, MN, 55901-7829, US

(73) Assignee: International Business Machines Corporation, Armonk, NY (US)

(21) Appl. No.: 10/731,079

(22) Filed: Dec. 9, 2003

(51) Int. Cl. G06F 17/30

(52) U.S. Cl. 707/3

(57) ABSTRACT

Methods, systems, and articles of manufacture that may be used for returning annotation data associated with a set of user data are provided. While annotations for different type data objects may have varying types and numbers of annotation fields, the annotation data contained therein may be consolidated and returned in a uniform annotation data structure (e.g., having a fixed number of fields) used for all types of annotations. For some embodiments, the annotation data structure may contain the consolidated annotation data, as well as a linking value identifying the corresponding annotated data.

### CROSS-REFERENCE TO RELATED APPLICATIONS

The present application is related to commonly-owned U.S. Pat. No. 6,519,603, entitled “Method And System For Organizing An Annotation Structure And For Querying Data And Annotations”, commonly-owned, co-pending application Ser. Nos. 10/083,075, entitled “Application Portability And Extensibility Through Database Schema And Query Abstraction,” 10/600,014, entitled “Universal Annotation Management System”, and 10/600,382, entitled “Heterogeneous Multi-Level Extendable Indexing For General Purpose Annotation Systems”, which are herein incorporated by reference.

### BACKGROUND OF THE INVENTION

1. Field of the Invention

The present invention relates to the field of data entry and retrieval and, more particularly, to a method and system for retrieving annotation data associated with a variety of heterogeneous data objects.

2. Description of the Related Art

An annotation system is used to create, store, and retrieve descriptive information about objects. Virtually any identifiable type of object may be annotated, such as a matrix of data (e.g., a spreadsheet or database table), a text document, or an image. Further, subportions of objects (sub-objects) may be annotated, such as a cell, row, or column in a database table or a section, paragraph, or word in a text document. Some annotation systems store annotations separately, without modifying the annotated data objects themselves. For example, annotations are often contained in annotation records stored in a separate annotation store, typically a database. The annotation records typically contain information about the annotations contained therein, such as the creation date and author of the annotation, and an identification of the annotated data object, typically in the form of an index.

An indexing scheme is typically used to map each annotation to the annotated data object or sub-object, based on the index. Therefore, the index must provide enough specificity to allow the indexing scheme to locate the annotated data object (or sub-object). Further, the indexing scheme must work both ways: given an index, the indexing scheme must be able to locate the annotated data object and, given an object, the indexing scheme must be able to calculate the index for use in classification, comparison, and searching (e.g., to search for annotations for a given data object). Databases are typically used as the annotation store for performance reasons, so that annotation records can be efficiently stored and retrieved.

When a user views a portion of a data (e.g., results received in response to issuing a query), it is generally desirable to display annotations made for data objects in the view. However, different types of annotations (e.g., made for different types of data objects) may contain different types and different numbers of fields containing annotation data. For example, annotations associated with a molecule may have a comment field, while annotations with an image may include a comment field, as well as a field indicating quality of the image. Such annotation data may be combined with the corresponding data, using conventional join techniques, as shown in TABLE I below, which has user data in the first two columns and annotation data in the last three. Unfortunately, this approach may prove less than ideal for a number of reasons. For example, there is no explicit information tying an annotation field to the associated data field. While the descriptive field names may be used in this simple example, in some case, there may been several fields of user and/or annotation data with similar field names, which may make this difficult. Further, several rows shown in TABLE I have at least part of the field data duplicated, in cases where there are multiple annotations per data field (e.g., the first and second rows) or for different fields in the same record (e.g., the third and fourth rows). Partial data duplication may lead to substantial inefficiencies, particularly for records with a large number of fields.

TABLE I
CONVENTIONAL USER AND ANNOTATION DATA EXAMPLE

| | | MOLECULAR | IMAGE | IMAGE |
|---|---|---|---|---|
| MOLECULE | IMAGE | ANNO_COMMENT | ANNO_COMMENT | ANNO_QUALITY |
| Folate | 1dhf.gif | Need to rerun | — | — |
| | | experiment . . . | | |
| Folate | 1dhf.gif | Experiment was rerun . . . | — | — |
| Methotrexate | 4dfr.gif | — | Image taken using . . . | 5 |
| Methotrexate | 4dfr.gif | Experiment was | — | — |
| | | run under the . . . | | |
| — | Nci2.gif | — | — | — |

Still further, in order to accommodate a potentially large varying number of annotation fields, a corresponding large number of custom functions may be required. For example, a given function may be chosen according to the possible fields of annotation data that may be returned for a given set of user data. Creating and maintaining a large number of functions may prove to be a challenge to developers. Further, the fact that the number and type of columns of the table returned by different functions varies may present another challenge to developers of applications calling such functions.

Accordingly, there is a need for a method for returning annotation data, potentially involving a varying number of fields, in a uniform manner.

### SUMMARY OF THE INVENTION

The present invention generally is directed to a method, system, and article of manufacture for retrieving annotation data for a variety of different type data objects.

One embodiment provides a method for providing annotation information for a set of data. The method generally includes querying an annotation store to retrieve one or more annotation records, each annotation record associated with a portion of the set of data and having one or more annotation fields, generating a linking value identifying the portion of the set of data associated with the annotation records, consolidating data contained in the annotation fields, and returning an annotation data structure comprising a field containing the linking value and a field containing the consolidated data.

Another embodiment provides a method for providing user data and corresponding annotation data. The method generally includes receiving, from a requesting entity, a query to return the user data, retrieving the user data from a data source, retrieving, from an annotation store, one or more annotation records associated with the one or more annotated portions of the user data, consolidating annotation data contained in the annotation records, joining the consolidated annotation data with the user data to generate a data structure containing the consolidated data, and returning, to the requesting entity, the generated data structure.

Another embodiment provides a computer-readable medium containing a program for returning annotation data. When executed by a processor, the program performs operations generally including querying an annotation store to retrieve one or more annotation records, each annotation record associated with a portion of the set of data and having one or more annotation fields, generating a linking value identifying the portion of the set of data associated with the annotation records, consolidating data contained in the annotation fields, and returning an annotation data structure comprising a field containing the linking value and a field containing the consolidated data.

Another embodiment provides a system for indicating objects in a view of data having corresponding annotations, generally including an annotation database for storing annotation records containing annotations for the different type data objects and an executable component. The executable component is generally configured to query the annotation store to retrieve one or more annotation records, each annotation record associated with a portion of the set of data and having one or more annotation fields, generate a linking value identifying the portion of the set of data associated with the annotation records, consolidate data contained in the annotation fields, and return an annotation data structure comprising a field containing the linking value and a field containing the consolidated data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a computer system illustratively utilized in accordance with embodiments of the present invention.

FIGS. 2A and 2B are relational views of exemplary components according to one embodiment of the present invention.

FIG. 3 is a flow diagram of exemplary operations for retrieving and returning annotation data according to one embodiment of the present invention.

FIGS. 4A-4B illustrate exemplary data structures containing consolidated annotation data according to one embodiment of the present invention.

FIGS. 5A-5D are exemplary graphical user interface (GUI) screens according to one embodiment of the present invention.

### DETAILED DESCRIPTION OF THE PREFERRED EMBODIMENTS

The present invention provides methods, systems, and articles of manufacture for retrieving and returning annotation data for a variety of different type (i.e., heterogeneous) data objects. While annotations for the different type data objects may have varying types and numbers of annotation fields, the annotation data contained therein may be consolidated and returned in a uniform data structure (e.g., having a fixed number of fields) used for all types of annotations. For some embodiments, the annotation data structure may contain the consolidated annotation data, as well as a linking value identifying the corresponding annotated data. While the number of fields may be fixed, the consolidated annotation data may be considered dynamic metadata (data about data), as its size may vary with the number of fields and content of annotated data being consolidated.

As used herein, the term annotation generally refers to any type of descriptive information associated with one or more data objects. Annotations may exist in various forms, including textual annotations (descriptions, revisions, clarifications, comments, instructions, etc.), graphical annotations (pictures, symbols, etc.), sound clips, etc. While an annotation may exist in any or all of these forms, to facilitate understanding, embodiments of the present invention may be described below with reference to textual annotations as a particular, but not limiting, example of an annotation. Accordingly, it should be understood that the following techniques described with reference to textual annotations may also be applied to other types of annotations, as well, and, more generally, to any type of data object that references another data object. Further, as used herein, the term user data generally refers to any collection of data requested, displayed, viewed, or otherwise manipulated by a user (e.g., a human user or application), regardless of the underlying data type (e.g., whether a database table, document, schematic, etc.). However, to facilitate understanding, the following description will refer to specific embodiments that relate to relational user data arranged in rows and columns.

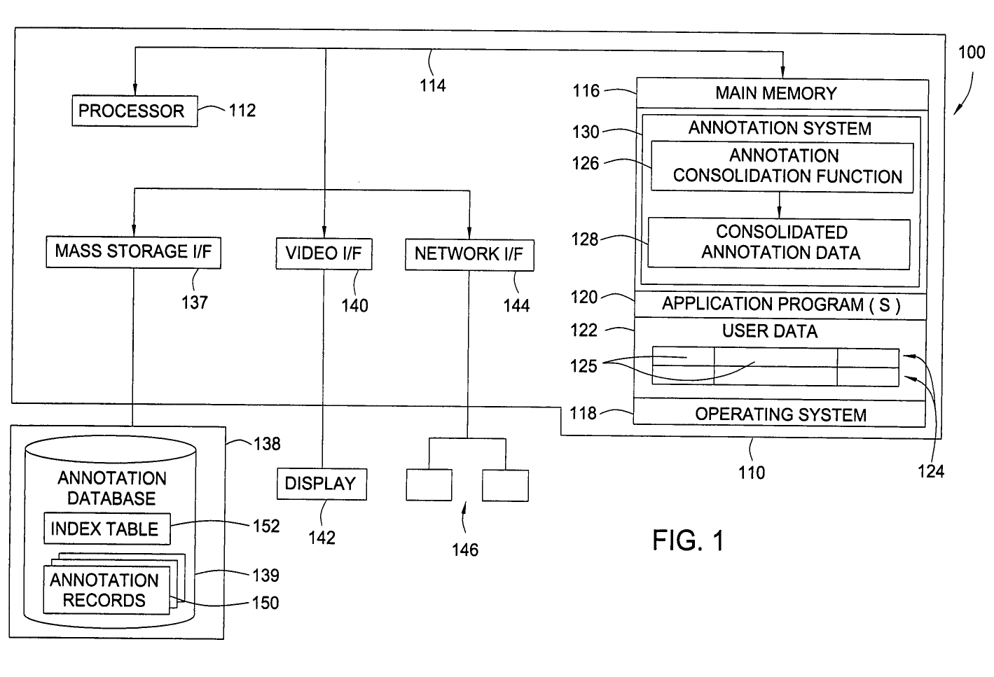

One embodiment of the invention is implemented as a program product for use with a computer system such as, for example, the computer system 110 of the data processing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Environment

Referring now to FIG. 1, the data processing environment 100 is shown. In general, the data processing environment 100 includes a computer system 110 and a plurality of networked devices 146. The computer system 110 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 110 is an eServer iSeries computer system available from International Business Machines (IBM) of Armonk, N.Y.

The computer system 110 could include a number of operators and peripheral systems as shown, for example, by a mass storage interface 137 operably connected to a direct access storage device (DASD) 138, by a video interface 140 operably connected to a display 142, and by a network interface 144 operably connected to the networked devices 146. The display 142 may be any video output device for outputting viewable information. The networked devices 146 may be any combination of any type networked devices, such as networked workstations, servers, printers, and network accessed storage (NAS) devices.

Computer system 110 is shown comprising at least one processor 112, which obtains instructions and data via a bus 114 from a main memory 116. The processor 112 could be any processor adapted to support the methods of the invention. The main memory 116 is any memory sufficiently large to hold the necessary programs and data structures. Main memory 116 could be one or a combination of memory devices, including Random Access Memory, nonvolatile or backup memory, (e.g., programmable or Flash memories, read-only memories, etc.). In addition, memory 116 may be considered to include memory physically located elsewhere in a computer system 110, for example, any storage capacity used as virtual memory or stored on a mass storage device (e.g., DASD 138) or on another computer coupled to the computer system 110 via bus 114.

The memory 116 is shown configured with an operating system 118. The operating system 118 is the software used for managing the operation of the computer system 110. Examples of suitable operating systems include such as IBM's OS/400, IBM's AIX, Unix, Linux, Microsoft Windows®, and the like. The memory 116 further includes at least one application 120 and an annotation system 130. For some embodiments, the annotation system 130 may be integrated with the operating system 118 and/or may be capable of operating in a stand alone manner, for example, without an application 120.

The application 120 and the annotation system 130 are software products comprising a plurality of instructions that are resident at various times in various memory and storage devices in the computer system 110. When read and executed by one or more processors 112 in the computer system 110, the application 120 and the annotation system 130 cause the computer system 110 to perform the steps necessary to execute steps or elements embodying the various aspects of the invention. The application 120 is generally configured to access data in a database, for example, by issuing queries. In some cases, queries issued by the database may return sets of results, shown as user data 122. The database may be a relational database and the results may be organized in rows and columns. Accordingly, the user data 122 may comprise one or more rows 124 of cells 125, with each cell 125 identified by a corresponding row-column pair.

As illustrated, the annotation system 130 may also include at least one annotation consolidation function 126 designed to retrieve annotations made for data objects of the user data 122 and return such annotation data in a consolidated format. For some embodiments, the annotation consolidation function 126 may return consolidated annotation data 128, along with one or more linking values identifying corresponding annotated portions of the user data 122. As will be described in greater detail below, the annotation consolidation function 126 may map fields of varying types and numbers into a uniform number of fields. In other words, the consolidated annotation data 128 may be contained in a data structure having a fixed number of fields, regardless of the type and number of fields in the corresponding annotation.

### An Exemplary Annotation System

The annotation system 130 is generally configured to allow users of the application program 120 to create, store, and retrieve annotations associated with various portions of a user data 122 (e.g., a cell 125, group of cells 125, or a row 124). The annotation system 130 may be any suitable type of annotation system and, for some embodiments, may be similar to the universal annotation system described in the commonly owned, co-pending application 10/600,014, entitled “Universal Annotation System,” filed Jun. 20, 2003, herein incorporated by reference. As described therein, the annotation system 130 may be separate from the application 120, an integral part of the application 120, or a “plug-in” component thereof.

The annotations may be contained in annotation records 150, for example, stored in an annotation database 139 (e.g., in the DASD 138). The annotation records 150 may also contain various information about the annotation, such as the author and creation date of the annotation, as well as an index identifying the annotated data object 122. For some embodiments, the annotation system 130 may include an indexing component configured to generate an index for an annotated data object, for example, based on one or more parameters identifying the annotated data object (e.g., a database table, row, and/or column). Indexes created for annotated data objects 122 may be stored in an index table 152 in the annotation data base 139. For some embodiments, the index table 152 may be queried to identify annotations for portions of the user data 122.

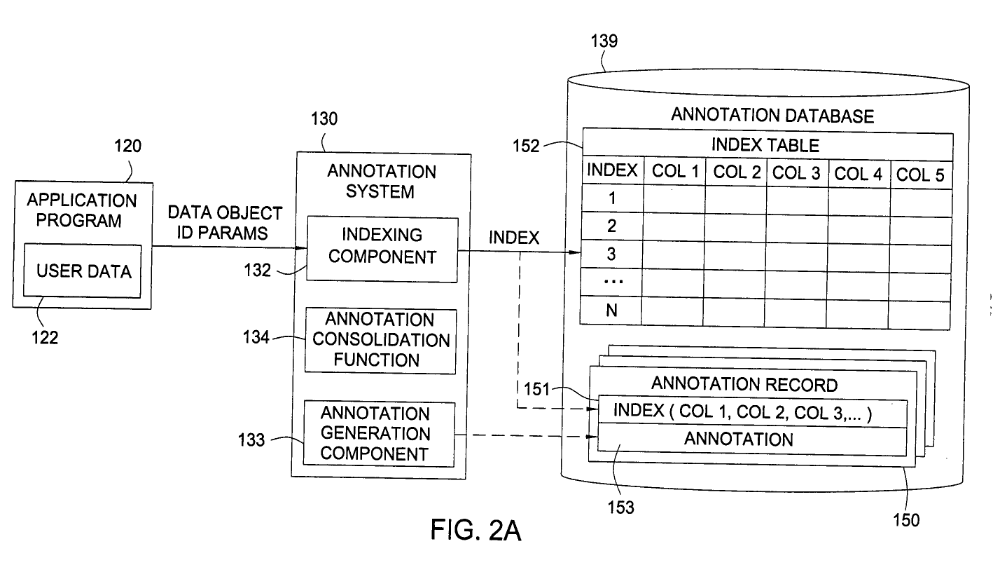

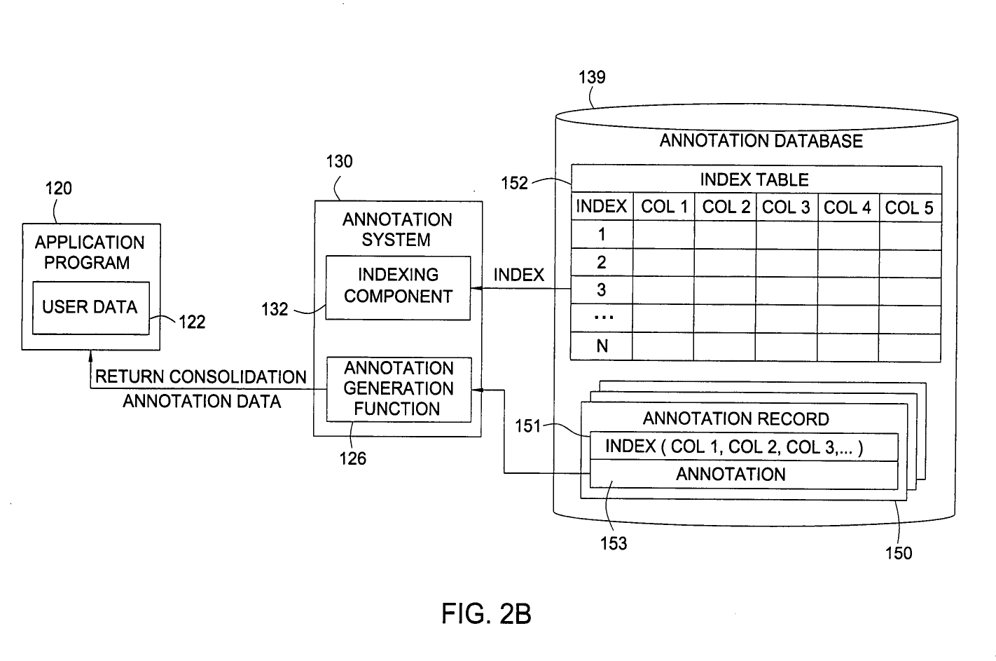

FIGS. 2A and 2B are relational views of various components of the annotation system 130 shown during annotation generation and annotation retrieval, respectively, that illustrate the creation and utilization of indexes according to one embodiment of the present invention. As illustrated in FIG. 2A, an annotation 153 for a portion (e.g., a row, cell, or group of rows) of the user data 122 (identified by a set of ID parameters) may be created via an annotation generation component 133. As described in the previously referenced application Ser. no. 10/600,014, the annotation 153 may comprise several fields of varying types of data (e.g., comment fields, numeric fields such as quality, grade, a selection from a list, etc.), which may depend on an annotation structure used to create the annotation 153.

An indexing component 132 may create an index 151 based on the set of ID parameters, for use in indexing an annotation 153 created for the identified data object. The annotation 153 and corresponding index 151 may be stored in an annotation record 150. For some embodiments, entries in the index table 152 may simply contain ID parameters indicating an annotated data object (e.g., identification of a data source/table, a row, and column). For other embodiments, however, table entries may include index parameters generated based on the ID parameters. Such indexing techniques are described in the commonly assigned, co-pending application Ser. No. 10/600,382, entitled “Heterogeneous Multi-Level Extendable Indexing For General Purpose Annotation Systems,” filed Jun. 20, 2003.

In any case, as illustrated in FIG. 2B, the annotation database 139 and/or index table 152 may be queried to identify which objects of user data 122 are annotated. For example, the index table 152 may be queried to obtain a global unique identifier (GUID) of annotations using ID parameters of objects of user data 122. Using the GUIDs, corresponding annotation records 150 may be retrieved. As illustrated, prior to returning the annotations to the application 120, the annotation consolidation function 126 may consolidate the annotation data stored therein.

### Consolidating Annotation Data

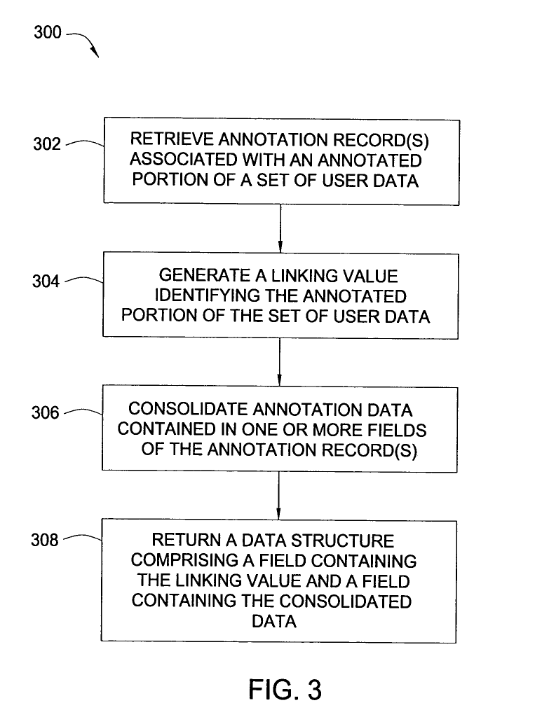

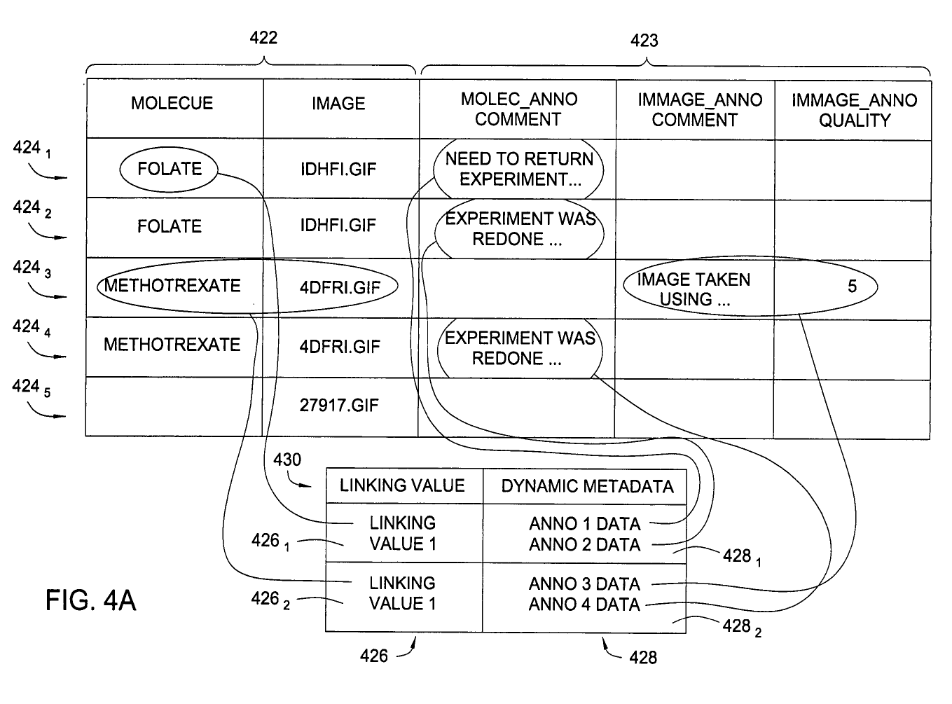

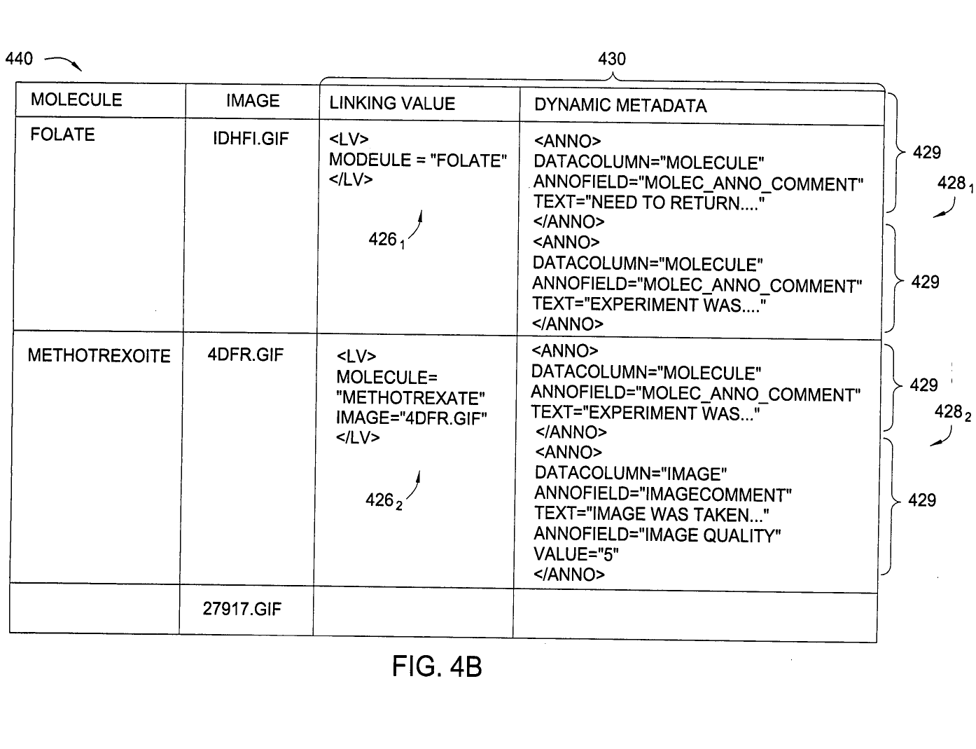

FIG. 3 is a flow diagram of exemplary operations 300 that may be performed, for example, by the annotation consolidation function 126, to return annotated data in a consolidated format. The operations 300 may be described with simultaneous reference, at appropriate times, to FIGS. 4A-4B which illustrate exemplary data structures containing user data and corresponding annotation data.

The operations 300 begin, at step 302, by retrieving one or more annotation records associated with an annotated portion of a set of user data. For example, FIG. 4A illustrates an exemplary set of user data 422 and associated annotation data 423. As previously described with reference to TABLE I, there is no explicit information indicating which data column is associated with a particular annotation field. Further, joining the user data 422 and annotation data 423 as shown results in a column for each available annotation field and several rows 424 with partially duplicated columns of data. However, an annotation structure 430 (e.g., a relational table, as shown) may be generated with a uniform number of fields (two in the illustrated example), that contains consolidated annotation data 428 and linking values 426 that may be used to join the consolidated annotation 428 data with the user data 422.

At step 304, a linking value 426 identifying the annotated portion of the set of user data 422 is generated. At step 306, annotation data 423 contained in one or more fields of the annotation records is consolidated (labeled Dynamic Metadata in data structure 430). At step 308, a data structure 430 comprising a field containing the linking value and a field containing the consolidated data is returned. As will be described in greater detail below with reference to FIG. 4B, the data structure 430 may be returned separately, or joined with user data 422.

In general, the linking value 426 may include any suitable information that identifies a corresponding annotated portion of user data 122. In some cases, the linking value may include primary key data or compound primary key data. For example, molecule names may be used as primary keys for a table storing molecule information, while image names may be used as primary keys for a table storing images. As shown in FIG. 4B, a linking value 426₁ for annotations associated generally with molecules may include a single primary key value (e.g., the molecule name folate), while a linking value 426₂ for annotations associated with both a molecule and image may include multiple primary key values (e.g., the molecule name methotrexate and an image name 4dfr.gif).

To consolidate the annotation data, corresponding annotation fields may be mapped to the consolidated annotation data field (labeled Dynamic Metadata) of the consolidated annotation structure 430. As illustrated in FIG. 4B, data from multiple annotations may be included in separate sections 429, separated by a tag (e.g., an XML tag “ANNO”), which may facilitate parsing by a receiving entity, such as an application 120. As shown, each section 429 may include a Data Column name field explicitly indicating a corresponding column of user data 422. Each section may also include a Annotation Field name field, followed by a Data field with data contained in the field. As illustrated, the name of the data field may indicate the type of data contained therein (e.g., Text or Value).

As shown, consolidated data 428₂ for a second row of user data 422 may include data from an annotation with multiple fields (e.g., an image annotation may include Image Comment and Image Quality fields), with each field having a separate Annotation Field name and Data field. Further, while not shown in this simplified example, in some cases, an annotation may be associated with a group of cells. In such cases, more than one Data Column name may be listed, indicating the annotation data to follow corresponds to user data 422 spanning multiple columns. Annotations may also be associated with an entire row, which may also be indicated by a specific value in a Data Column name field (e.g., “Row”) or by providing a separate field.

For some embodiments, annotation information may be retrieved after the corresponding user data has been retrieved (e.g., by the application 120). For other embodiments, user data and annotation data may be retrieved simultaneously. For example, as described in the previously referenced application Ser. No. 10/600,014, user data and annotation data may be retrieved in response to a single query, via an annotation browser component.

In either case, the user data 422 and consolidated annotation data 423 may be joined, for example, using the generated linking values 426 in the join condition. As illustrated, the resultant data structure 440 does not have rows with partially duplicated column data, as the joined table shown in TABLE I and in FIG. 4A. Further, the consolidated annotation data contains explicit references to corresponding portions of user data 422.

### Utilizing Consolidated Annotation Data

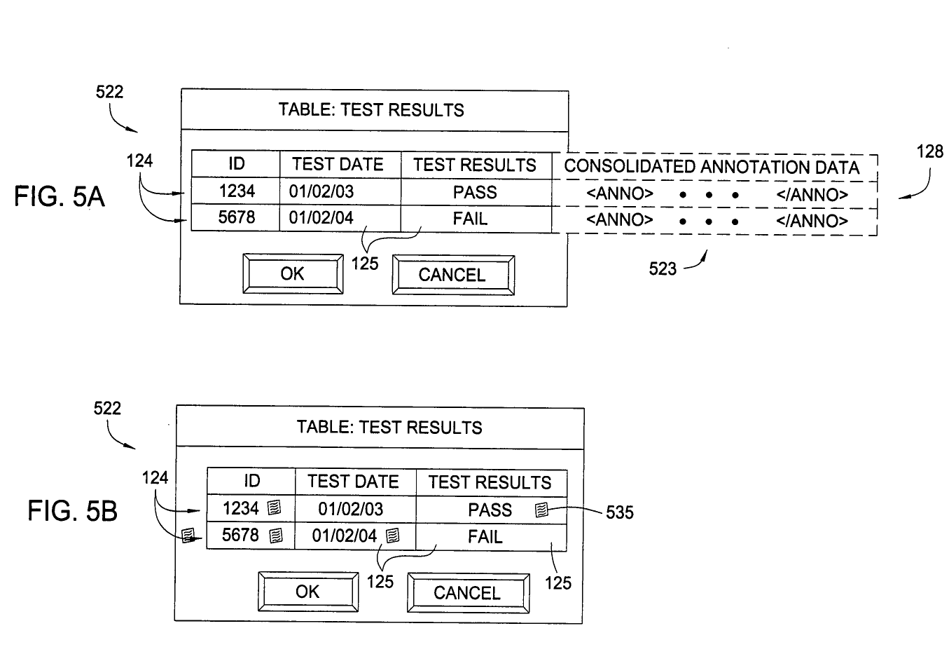

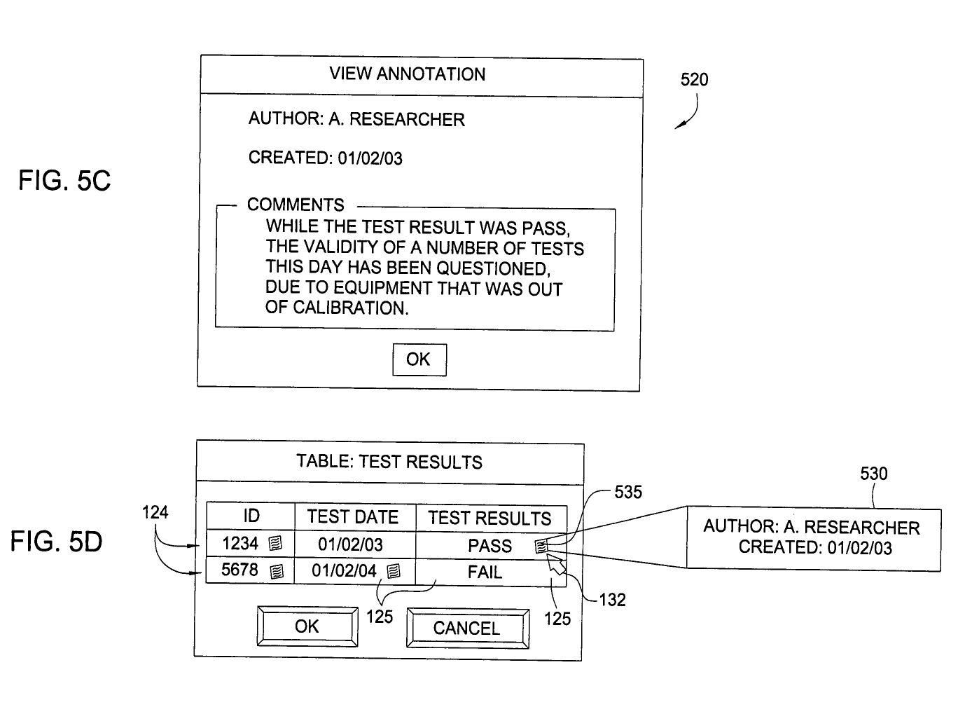

FIGS. 5A-5D are exemplary graphical user interface screens that illustrate how an application 120 may utilize consolidated annotation data when displaying corresponding user data (test results in the example). As illustrated in FIG. 5A, the consolidated annotation data 523 is typically not displayed in its raw format, but may be maintained as “hidden” fields and utilized in various ways. However, the consolidated annotation data 523 may be parsed to identify annotated cells 125 (or rows 124), for example, based on the Linking Value and Data Column name fields.

Annotated objects may be indicated, for example, by displaying annotation icons 535 proximate annotated objects, as illustrated in FIG. 5B. For some embodiments, if multiple annotations exist for a single object, a single icon indicating multiple annotations (e.g., having a different color than other icons indicating a single annotation) or multiple annotation icons may be displayed.

In response to a user selecting the annotation icon 535 (e.g., via a mouse click), the corresponding annotation may be displayed, for example, in the GUI screen 520 shown in FIG. 5C. The GUI screen 520 may be generated, for example, by parsing the consolidated annotation data 523 to identify annotation fields to include in the GUI screen 520 and populating the fields with the corresponding data. Conveniently, all the information necessary to generate the GUI screen 520 is contained in the consolidated annotation data 523 and the application 120 does not have to again communicate with the annotation system 130.

For some embodiments, as illustrated in FIG. 5D, a user may be able to view a limited amount of information regarding an annotation (e.g., consolidated data stored in Author and Creation date fields) as “fly-over” text 530, for example, by placing a mouse cursor 532 over the corresponding annotation icon 535. For other embodiments, because the consolidated annotation data 523 is complete, the entire annotation may be displayed as “fly-over” text.

### CONCLUSION

While the number and types of fields included in an annotation for different type data objects may vary, embodiments of the present invention allow annotation data contained therein to be returned in a data structure having a uniform number of fields. As a result, a relatively small number of functions may be required to efficiently retrieve the annotation data, despite the varying number of fields and data types of the annotations. The consolidated annotation data may be formatted in a manner that facilitates parsing by a retrieving application.

While the foregoing is directed to embodiments of the present invention, other and further embodiments of the invention may be devised without departing from the basic scope thereof, and the scope thereof is determined by the claims that follow.

1. A method for providing annotation information for a set of data, comprising:
querying an annotation store to retrieve one or more annotation records, each annotation record associated with a portion of the set of data and having one or more annotation fields;
generating a linking value identifying the portion of the set of data associated with the annotation records;
consolidating data contained in the annotation fields; and
returning an annotation data structure comprising a field containing the linking value and a field containing the consolidated data.

2. The method of claim 1, further comprising returning the set of data with the annotation data structure.

3. The method of claim 1, wherein:
the set of data is a relational table containing query results; and
the method further comprises joining the annotation data structure with the set of data.

4. The method of claim 3, comprising joining the annotation data structure with the set of data prior to returning the annotation data structure.

5. The method of claim 1, wherein the linking value comprises primary key data.

6. The method of claim 5, wherein the primary key data comprises compound primary key data involving at least two fields.

7. The method of claim 1, further comprising receiving a query to retrieve the annotation data, the query identifying the portion of the set of data associated with the annotation records.

8. The method of claim 1, further comprising:
receiving a query to retrieve the set of data; and
issuing the query against a data source separate from the annotation store to retrieve the set of data.

9. A method for providing user data and corresponding annotation data, comprising:
receiving, from a requesting entity, a query to return the user data;
retrieving the user data from a data source;
retrieving, from an annotation store, one or more annotation records associated with the one or more annotated portions of the user data;
consolidating annotation data contained in the annotation records;
joining the consolidated annotation data with the user data to generate a data structure containing the consolidated data; and
returning, to the requesting entity, the generated data structure.

10. The method of claim 9, further comprising generating one or more linking values identifying the one or more annotated portions of the user data.

11. The method of claim 10, wherein the linking values are utilized in the joining.

12. A computer-readable medium containing a program for returning annotation data which, when executed by a processor, performs operations comprising:
querying an annotation store to retrieve one or more annotation records, each annotation record associated with a portion of the set of data and having one or more annotation fields;
generating a linking value identifying the portion of the set of data associated with the annotation records;
consolidating data contained in the annotation fields; and
returning an annotation data structure comprising a field containing the linking value and a field containing the consolidated data.

13. The computer-readable medium of claim 12, wherein the operations further comprise returning the set of data with the annotation data structure.

14. The computer-readable medium of claim 12, wherein:
the set of data is a relational table containing query results; and
the operations further comprise joining the annotation data structure with the set of data.

15. The computer-readable medium of claim 12, wherein the operations further comprise receiving a query to retrieve the annotation data, the query identifying the portion of the set of data associated with the annotation records.

16. The computer-readable medium of claim 12, wherein the operations further comprise:
receiving a query to retrieve the set of data; and
issuing the query against a data source separate from the annotation store to retrieve the set of data.

17. A system for providing annotation information for a set of data, comprising:
an annotation database for storing annotation records containing annotation data; and
an executable component configured to query the annotation store to retrieve one or more annotation records, each annotation record associated with a portion of the set of data and having one or more annotation fields, generate a linking value identifying the portion of the set of data associated with the annotation records, consolidate data contained in the annotation fields, and return an annotation data structure comprising a field containing the linking value and a field containing the consolidated data.

18. The system of claim 17, wherein the executable component is further configured to return the set of data with the annotation data structure.

19. The system of claim 18, wherein the executable component is further configured to retrieve the user data from a data source separate from the annotation store.

20. The system of claim 18, wherein the executable component is further configured to join the consolidated annotation data with the user data, using the linking value, prior to returning the set of data with the annotation structure.
